(19) United States
(12) Patent Application Publication
(10) Pub. No.: US 2014/0359268 A1
(43) Pub. Date: Dec. 4, 2014

(54) Methods of Securely Changing the Root Key of a Chip, and Related Electronic Devices and Chips

(71) Applicant: Broadcom Corporation, Irvine, CA (US)

(72) Inventors: Antti JAUHIAINEN, Kempele (FI); Vesa PELLIKKA, Oulu (FI); Arnaud BOSCHER, Rennes (FR); Kenichi ITO, Tokyo (JP); Taina Maria ANTTILA, Kello (FI)

(73) Assignee: Broadcom Corporation, Irvine, CA (US)

(21) Appl. No.: 14/291,430

(22) Filed: May 30, 2014

(30) Foreign Application Priority Data
Jun. 3, 2013 (GB) 1309842.1

(51) Int. Cl. H04L 9/08; G06F 21/44; G06F 21/57

(52) U.S. Cl. CPC H04L 9/08; G06F 21/575; G06F 21/44
USPC 713/2; 713/168; 713/176

(57) ABSTRACT

Disclosed are methods and apparatus for changing a security key on a computer chip that has a CPU, a first OTPROM (OTPROM1) storing a root key of the chip or derivative thereof (RKPUB1), and a second OTPROM (OTPROM2) on which the chip manufacturer stores nothing. A ROM of the chip stores a first software program (SW1). A device manufacturer can take that chip and interface it to a mass memory of a memory block of an electronic device, then execute a second software program (SW2) that is stored on the mass memory only if SW2 is authenticated by SW1 using the RKPUB1. Then a new root key of the chip or derivative thereof (RKPUB2) is provided (via SW2 or a USB connection for example) which is stored to the OTPROM2 via a security service portion of SW1. Thereafter RKPUB2 can be used to authenticate SW2.

### TECHNICAL FIELD

The present invention relates to a method for changing a security key on a computer chip, an electronic device, a method for making a computer chip, and a computer chip. The exemplary and non-limiting embodiments of this invention relate generally to wireless communication systems, methods, devices and computer programs. Specific examples relate to programming a new root security key on a processing chip that is commonly used in modern electronic devices after an initial root key has already been programmed to the chip.

### BACKGROUND

Most modern electronic devices contain one or more chips which contain one or more processors which execute software. Non-limiting examples of such electronic devices include smartphones, tablets, laptops, TVs, and embedded devices that control larger systems such as an embedded controlling system of an automobile or other type of vehicle. Software in each processor or processor system has been partitioned in a variety of ways. Typically the lowest layer of partitioned software, which is closest to the processor hardware, is referred to as the firmware. Installation of the firmware is usually strictly controlled by the manufacturer of the device or the manufacturer of the chip which contains the processor that executes the software. The firmware forms a virtual execution environment for the operating system. Installation of the operating system may be controlled by the device or chip manufacturers but it can also be left for the end user. The operating system forms a virtual execution environment to applications or to further execution environments. Depending on the type of the electronic device, software running on top of the operating system can be installed and controlled by the end user, the manufacturer, or any party between them. As an example of this, the device manufacturer of modern smartphones usually controls installation of the operating system and the firmware, while the end user, reseller or other party possessing the device are free to install or create new applications or execution environments on top of the operating system.

There are two main phases of software installation to consider for achieving the above control over software, though they can take very different forms in different implementations. The first installation phase is generally termed provisioning, where software is first provisioned to the device or embedded system. The second installation phase is generally termed loading, where software is loaded to be executed by a processor or processor system. For purposes herein, the provisioning phase refers to programming of internal read-only memories (ROMs) during chip and device manufacturing, or transferring software to a device's mass memory system. The loading phase refers to preparing the software for execution at boot, which might mean for example moving it from the mass memory to the random access memory (RAM) and performing related security checks. Both the provisioning and loading phases need to be controlled to be able to control software installation.

It is important to secure that when the device or embedded system boots, that device or system ends up at a predefined state. From that predefined state, the end user or some other party may be given certain authority such as to install additional software. There are known methods for securing a boot to this predefined state in which the chips of the device or embedded system accept only authorised software images to be loaded for execution. In one of these methods, part of the boot software is located on the ROM of the chip. Software images to be loaded for execution are signed digitally, and stored on this same chip is the necessary key data, or a derived-value of this necessary key data, for checking the signature. This key data is known as the root key of the chip. Checking if the software image has been signed using the corresponding legitimate key is known as authentication of the software image. Ensuring that the software image has not been changed after signing is known as integrity checking of the software image. Both authentication and integrity checking utilise the root key of the chip.

This root key of the chip is used for authenticating the first software image to be loaded when booting the chip/system, for example from the mass memory. After provisioning the root key on the chip, it is possible to execute on that chip only software images which have been signed with the corresponding key. The root key and the signing key are created as an asymmetric key pair: the root key corresponds to the public part and the signing key corresponds to the private part so that the party who has created the root key possesses also the signing key and only that party is able to sign software images that the chip will accept.

In current practice, the root key (or a derived-value) is stored in the chip in such a way that, once stored, it can never be changed or erased. It is considered safe to provision the root key on the chip during manufacture of the chip so that the root key is installed when the chips leave the factory. If the root key has been created and delivered to the chip manufacturer by the customer who has ordered the chips, then only that customer is able to sign software images for that chip. If the root keys were not provisioned to the chips at the chip manufacturing phase, it would be possible for a third party to maliciously provision the root key and sign software images, which would be a substantial security breach.

The “customer” who has ordered the chips may refer to a manufacturer of a smartphone of a vehicle-embedded device, and more generally refers to all those parties participating in device manufacturing who create the keys, deliver the root key to the chip manufacturer, sign the software images, and provision them to the device. The key generation and software image signing could take place at the customer's research and development department or in the customer's product manufacturing line for example. When the customer receives the chip, it assembles the chip on the printed circuit board (PCB) of the device and provisions the software images to the mass memory of the device, leaving the device ready to boot. This may be secure but it is inflexible: the device manufacturer (“customer”) must always sign software using exactly that key which was generated before ordering the chips. The signing keys cannot be created independently of the chip manufacturing, thus losing some flexibility that is often available with other types of software. For example, the device manufacturer might want to sign different variants of the software that go to its different classes of customers with different keys. The device manufacturer might prefer to allocate the chips to different variances/types of the device only after chip manufacturing, and use different signing keys to the software of the different device variants or types. And in some cases it is not compatible with the processes of the device manufacturer to create the keys before ordering the computer chips.

U.S. Pat. No. B2-7,506,381 describes a two phase method for securing that a device only accepts authorised software at boot. In the first phase the chip checks the digital signature of the first software image to be loaded using the key material stored on a ROM inside the chip, while in the second phase the second software image to be loaded is checked against key material stored on an EEPROM outside of the chip. In this case, the first software image must always be signed with the signing key which matches the root key stored on the chip, and the keys still cannot be changed after storing the root key.

### BRIEF DESCRIPTION OF THE DRAWINGS

FIG. 1 shows a high level schematic block diagram of an example electronic device having a system-on-a-chip (SOC) that may be adapted to implement the teachings herein;

FIG. 2 shows a schematic block diagram illustrating portions of FIG. 1 in further detail;

FIGS. 3 and 4 illustrate an example of certain process steps performed by the chip manufacturer and the device manufacturer according to exemplary embodiments of the invention, where FIG. 3 illustrates software programs and keys/certificates that are stored on certain hardware/memories and FIG. 4 is a high level flow chart;

FIG. 5 shows a logic flow diagram that illustrates further detail of an example of a method for making a computer chip according to these teachings, where the computer chip is completed and ready for shipment to the device manufacturer for assembly into an electronic device according to the example herein; and

FIG. 6 shows a logic flow diagram that illustrates further detail of an example of a method for making an electronic device according to these teachings using a computer chip such as one or more chips made according to FIG. 5.

### DETAILED DESCRIPTION

According to a first aspect of the present invention, there is provided a method for changing a security key on a computer chip, the computer chip comprising at least one processor, at least two one-time programmable memory spaces (OTPROMs) of which a first of the one-time programmable memory spaces (OTPROM1) has stored thereon a root key of the chip or a derivative thereof (RKPUB1) and nothing is stored on a second of the one-time programmable memory spaces (OTPROM2), and a read only memory (ROM) having stored thereon a first software program (SW1), the method comprising:

interfacing the chip to electronically communicate with a memory block of an electronic device comprising the memory block, the memory block having at least a mass memory;

only if a second software program SW2 stored on the mass memory is authenticated by the SW1 using the RKPUB1, executing the SW2;

providing a new root key of the chip or a derivative thereof (RKPUB2) which is stored to the OTPROM2 via a security service portion of the SW1; and

using the RKPUB2 to authenticate the SW2 when executing the SW2 after the RKPUB2 is stored to the OTPROM2.

According to a second aspect of the present invention, there is provided an electronic device comprising: a computer chip comprising at least one processor, at least two one-time programmable memory spaces (OTPROMs) and a read only memory (ROM); and a memory block comprising at least a mass memory and the memory block is electronically interfaced to communicate with the computer chip; wherein a first of the one-time programmable memory spaces (OTPROM1) has stored thereon a root key of the chip or a derivative thereof (RKPUB1); a second of the one-time programmable memory spaces (OTPROM2) has stored thereon a new root key of the chip or a derivative thereof (RKPUB2); the mass memory has stored thereon a second software program (SW2); and the ROM has stored thereon a first software program (SW1) which includes a first boot software which, when executed, authenticates SW2 and thereafter initiates execution of SW2 which includes second boot software; the SW2 can be authenticated using the RKPUB1 or the RKPUB2.

According to a third aspect of the present invention, there is provided a method for making a computer chip, the method comprising: fabricating a computer chip comprising at least one processor, at least two one-time programmable memory spaces (OTPROMs), and a read only memory (ROM); storing on a first of the one-time programmable memory spaces (OTPROM1) a root key of the chip or a derivative thereof (RKPUB1); storing on the ROM a first software program (SW1) for booting the chip; and providing the chip to a customer with the RKPUB1 stored on the OTPROM1, the SW1 stored on the ROM, and nothing stored on a second of the one-time programmable memory spaces (OTPROM2).

According to a fourth aspect of the present invention, there is provided a computer chip comprising: at least one processor, at least two one-time programmable memory spaces (OTPROMs), and a read only memory (ROM); wherein a first of the one-time programmable memory spaces (OTPROM1) has stored thereon a root key of the chip or a derivative thereof (RKPUB1); the ROM has stored thereon a first software program (SW1) for booting the chip; and nothing is stored on a second of the one-time programmable memory spaces (OTPROM2).

In another example, there may be provided a method for changing a security key on a computer chip. In this example, the method comprises: providing the computer chip and providing an electronic device comprising a memory block having at least a mass memory. The computer chip comprises at least one processor, at least two one-time programmable memory spaces (OTPROMs) of which a first of the one-time programmable memory spaces (OTPROM1) has stored thereon a root key of the chip or a derivative thereof (RKPUB1) and nothing is stored on a second of the one-time programmable memory spaces (OTPROM2), and the chip further comprises a read only memory (ROM) having stored thereon a first software program (SW1). Further in the method, the chip is interfaced to electronically communicate with the memory block in the device; a second software program (SW2) is stored on the mass memory; and then only if the SW2 is authenticated by the SW1 using the RKPUB 1 the SW2 is executed. The method proceeds with providing a new root key of the chip or a derivative thereof (RKPUB2), which is stored to the OTPROM2 via a security service portion of the SW1; and then using the RKPUB2 to authenticate the SW2 when executing the SW2 after the RKPUB2 is stored to the OTPROM2.

Some examples of embodiments of the present invention provide a way for the manufacturer to re-claim some flexibility in how it authenticates and verifies software, particularly boot software, so that it need not always use the same exact root key as was provisioned during manufacture of the chip.

Further features and advantages of the invention will become apparent from the following description of preferred embodiments of the invention, given by way of example only, which is made with reference to the accompanying drawings.

These teachings relate to methods and apparatus for securing that only defined software can be executed in an electronic device, and that the electronic device boots in a controlled manner to a known/predetermined state. These teachings therefore relate to electronic devices which include one or more processors which execute software, and manufacturing processes of the processor chips that are components of the devices and of the devices themselves. These teachings may be applied to manufacturing of chips and of a device or embedded system using such a chip or chips as components, and securely installing software on them, in a way that the device or embedded system boots to a predefined state.

In an electronic device which contains several processor chips, one of the chips can be designed to act as a security master. A smartphone for example may have been designed on a system-on-a-chip (SOC) which contains, among other things, the main processor which may act as the security master. After the security master is booted, it may be allocated responsibilities to authenticate also software images of other chips within the device. In that case, the secure boot of the security master is required for controlling the software installation. The root key of the chip acting as the security master can be called the root key of the device. The examples below are in the context of a single SOC in a host device and this example extends readily to the security master of a device with multiple processors. These teachings may be implemented also in other chips that are not the security master such that a single electronic device may embody multiple different implementations of these teachings such as in the security master and in one or more other processors that are not security masters.

Above it was described that the chip manufacturer manufactures the chip with the root key being irreversibly programmed, and sometimes the customer who ordered the chip (typically the electronic device manufacturer) will provides the root key prior to chip manufacture. There are several reasons for the chip and device manufacturers to strictly control the installation process of at least certain parts of software. The value of the electronic device arises from its functionality and electronic functionality relies heavily on the combination of the physical device and the software that it runs (and that runs it). Replacing the software, even partially, may significantly change the device's functionality.

End users of the devices also expect a certain quality level, both in terms of ability of the device to fulfil end user expectations and in product safety. The targeted quality level can only be achieved by careful quality assurance which has to be carried out for the combination of a certain physical device and its software versions. When the software versions change, quality assurance must be at least partly repeated to remain valid. Additionally, it is possible to have type approval of the chips, and the devices themselves may be specific for a certain software version. There may also be intellectual property assets within the device that need to be protected, such as protected audio-visual content for example. In some cases it is possible to get unauthorised access to that content if certain parts of the software could be changed. Another example of the need to control the authenticity of the software is to protect a device (and its user) against rogue software such as viruses, trojans and other malware.

Embodiments of these teachings provide maximum flexibility for device manufacturer processes by presenting a method and apparatus for provisioning a root key on the chip during chip manufacturing, and additionally a method and apparatus for securely provisioning a new root key on the chip at a later date. In this manner, the chip manufacturer does not have to deliver chips without the root key, which would introduce security issues. Furthermore, the device manufacturer is free to generate a new signing key and new root key, provision the new root key on the device, and thereafter use the new signing key for validly signing software images.

U.S. Pat. No. B2-7,506,381 mentioned above in the background section describes certain prior art cryptographic methods, which can be used with implementations of these teachings also. Specifically, asymmetric keys are used for creating the digital signatures and checking the validity of them. In asymmetric encryption, a key pair is created; one key of the pair is often termed the public key and the other is the private key. The software image is signed with the private key and the signature is checked during boot with the corresponding public key of the key pair. There is no reason to store the private key on the device. It is cryptographically difficult to derive the private key based on the public key and other data stored on the device. In one implementation of this cryptography, the software image is digitally signed by calculating a hash of the software image using some known hash function, then signing the hash with the private key using some known asymmetric algorithm function, and then attaching the digital signature to the software image. At boot when the software image is loaded, the trusted boot software calculates the hash of the software image with the same hash function, applies a verification algorithm on the hash with the public key, and compares the results with the digital signature that is attached to the software image. If the results match it is reasonably concluded that the signer possesses the private key (meaning the software is authenticated) and the software image has not been changed after the digital signature was attached to it (meaning the software is validated). The public key is stored on the chip as such, or alternatively in some cases to save space only a hash of the public key (the hash is a value derived from the public key) is stored on the chip. From this example, it is clear that the root key is either the public key or a hash of it.

There may be a secure execution mode in the chip to securely perform the above cryptographic operations that authenticate and verify the software as described above. This secure execution mode can also be used for handling secret data, and for provisioning the new root key which is detailed below. In this manner it is possible to restrict access to part of the memories only in secure mode, and in certain implementations of these teachings the root key is stored in such a restricted-access memory. Reading or changing information which can be accessed only in the secure mode is not possible by software executed in the normal mode, or by analysing the device. One non-limiting example of such a secure execution mode can be seen at U.S. Pat. No. B2-7,437,574. When included in the chip, the secure mode improves the overall security beyond the security of the rest of the system. The secure mode is an additional layer of security and other implementations of these teachings are in a chip that does not support any secure execution mode beyond the normal boot process cryptographic security.

As mentioned above, embodiments of these teachings enable a device manufacturer to securely program a new root key in a chip, after the chip manufacturer has conventionally programmed its own root key (which typically is provided to the chip manufacturer by the device manufacturer or other customer purchasing the chip). Additionally, embodiments of these teachings do not require the device manufacturer to update the software in the mass memory once the new root key has been programmed. In some of these latter embodiments where a re-flash of software to the mass memory is not needed, there is also no need to re-boot the electronic device after the new root key is programmed/installed.

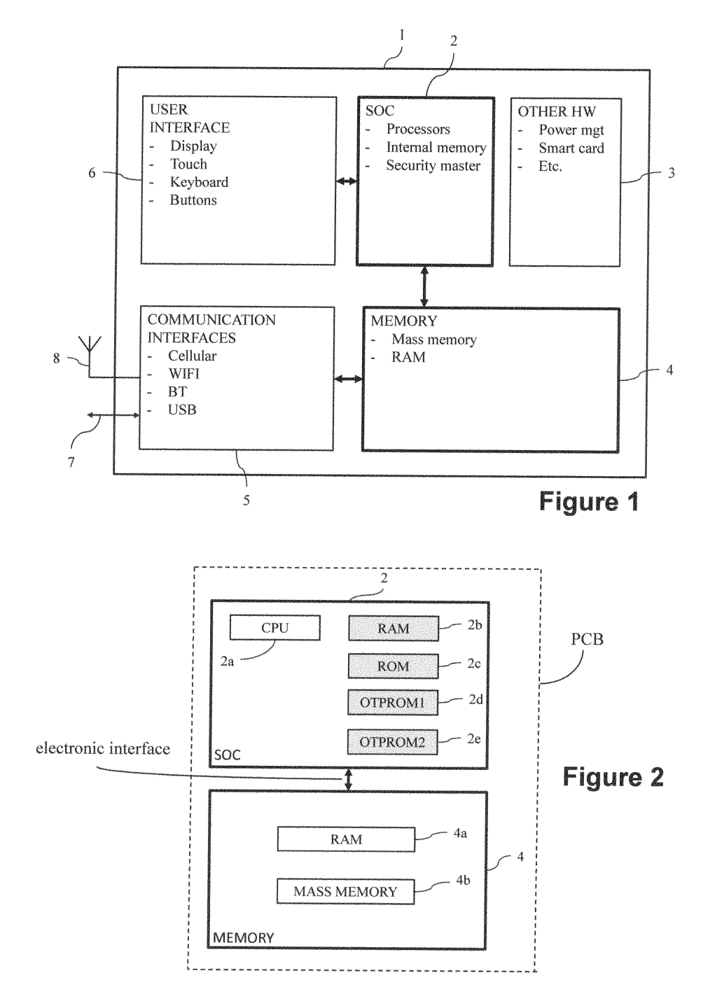

FIG. 1 shows a high level schematic block diagram illustrating an electronic device which is exemplary for embodying a chip according to these teachings. The device 1 may contain several chips which each have one or more processors for which software is installed from the mass memory. The system-on-a-chip (SOC) 2 acts as the master in this example, and also is the security master, of the device. When the device boots, one of the processors of the SOC 2 boots first.

The User Interface block 6 contains various modules related to interaction with the end user, such as key and touch screen recognition and feedback. Those components also include processors which execute memory, but for purposes of this explanation it may be considered that the user interface-related software has been installed permanently on the chip and so it is mentioned only for completeness in describing the device rather than for its security features. There is also in the device 1 a communication interface block 5 which contains the modules related to communicating with other devices, such as various radio access technology protocols and algorithms. These modules contain chips for which software is loaded from the mass memory at boot. The chips of the communication interface 5 can present a more limited security system than the security master, because the security master assists in security functions related to software loading. These teachings may be applied to the security master as well as to any individual chip in the device, such as in the communications interface block 5, for which software is installed from the mass memory at boot. The device 1 further has a memory 4 which contains device level mass memory and volatile memory.

Interface 8 is illustrated as a single antenna for brevity but represents transmit and receive arrangements for all the radio interfaces for which the device 1 is capable (assuming the device 1 is a radio device), for example one or more cellular bands/protocols, WIFI and Bluetooth. Interface 7 represents other non-wireless interfaces into and out of the device 1, such as for example USB and/or HDMI ports. Finally there is illustrated an “other hardware” (HW) block 3 which represents all of the other modules of the device 1 which may be a part of the device 1 but which are not essential for describing these teachings.

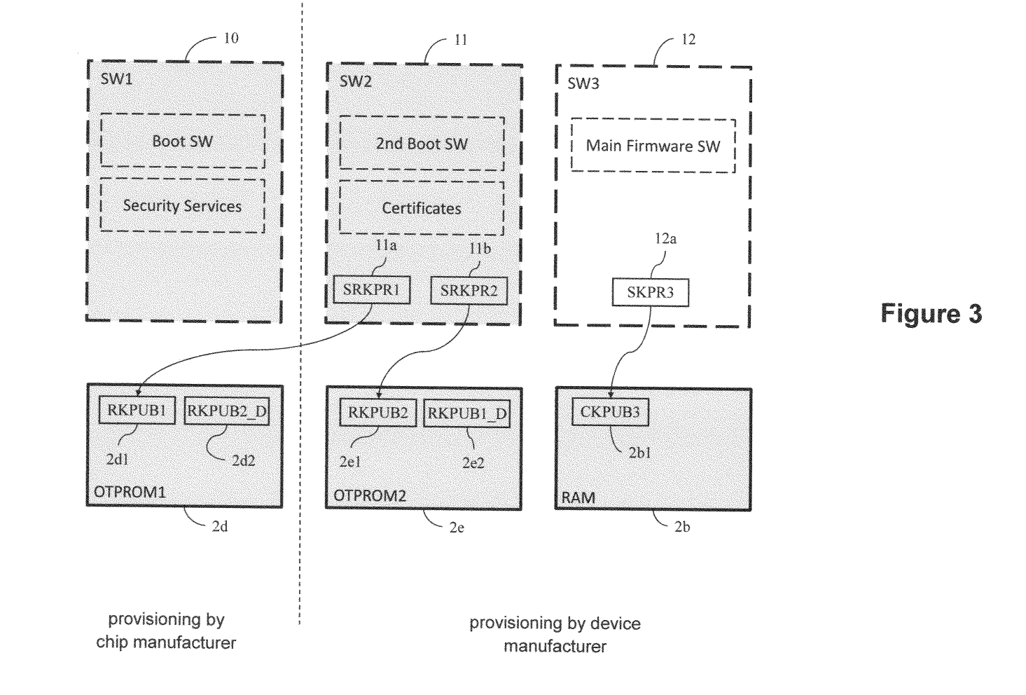

FIG. 2 details further two of the functional blocks of the device 1 shown at FIG. 1. For convenience a few acronyms used with reference to FIG. 2 are listed below. OTPROM is one-time programmable read only memory; RKPUB is the root key public key of a key pair (symmetric or asymmetric); and SW is software. OTPROM is known in the art: it is a memory space for which each bit storage location that can be written to one and only one time. There may be several write processes to the same OTPROM but each bit can be written to once and only once.
OTPROM1: memory location in the chip where RKPUB1 is stored.
OTPROM2: memory location in the chip where RKPUB2 is stored.
RKPUB1: Root key number 1 (stored in OTPROM1)
RKPUB1_D: field indicating that RKPUB1 is disabled.
RKPUB2: Root key number 2 (stored in the OTPROM2).
RKPUB2_D: field indicating that RKPUB2 is disabled.
SRKPR1: signature of SW2 using the private part of RKPUB1.
SRKPR2: signature of SW2 using the private part of RKPUB2.
SW1: software programmed in ROM memory used to authenticate SW2 (SW1 is first boot software).
SW2: software programmed in mass-memory that needs to be authenticated (before being executed) by SW1 leveraging either RKPUB 1 or RKPUB2 (SW2 is second boot software).

RKPUB1 and RKPUB2 can be a whole public key or a derivative value (for example, a hash value). RKPUB1 is typically programmed by the chipset manufacturer while RKPUB2 is typically programmed by the device manufacturer so RKPUB1 will be different from RKPUB2. When RKPUB1 is disabled by setting the field for RKPUB1_D, the RKPUB1 can no longer be used by SW1 to authenticate SW2. When RKPUB2 is disabled by setting the field for RKPUB2_D, the RKPUB2 cannot be programmed. In this example, SW2 is authenticated by SW1 and either RKPUB1 or RKPUB2 before SW2 can be executed.

FIG. 2 illustrates the SOC 2 and the memory block 4 in further detail with an electronic interface to enable communication between them. In the SOC 2 there is a central processing unit (CPU) 2a which represents the CPU which is started first in the boot sequence. For simplicity, in this example only one CPU is assumed to participate in the early boot phases but in other chip implementations the CPU function may be spread across more than one processor. The random access memory (RAM) 2b is a volatile memory inside the SOC 2. The CPU 2a is able to write and read data to and from the RAM 2b and execute code stored on the RAM 2b. The read only memory (ROM) 2c is a non-volatile memory inside the SOC 2 which contains boot code and other routines for the CPU 2a. Software for the ROM 2c is typically installed during chip (SOC 2) manufacturing. There are two OTPROMs 2d and 2e. Both are non-volatile memories inside the SOC 2 which can be programmed (written to) only once.

The OTPROM1 and OTPROM2 are shown in FIG. 2 as separate memories for clarity of this description, since they can be programmed using different methods, for example in terms of tools used, and at different times and by different entities as will be detailed below. As an example, in certain practical implementations the OTPROM1 and the OTPROM2 can be implemented as one memory which contains functionally different sections for chip manufacturing phase programming and for in-device programming. The OTPROM1 and the OTPROM2 can be implemented for example with eFuse technology which is a known technique that allows for the dynamic real-time reprogramming of computer chips (for background see for example an IBM press release dated Jul. 30, 2004 entitled “IBM Introduces Chip Morphing Technology”, at http://www-304.ibm.com/jct03001c/press/us/en/press/us/en/pressrelease/7246.wss).

The RAM 4a in the device memory block 4 represents an external volatile memory of the electronic device 1, implemented for example as a synchronous dynamic RAM (SDRAM). The SOC 2 can write and read data to and from the RAM 4a and execute code from it. The mass memory 4b of the device memory block 4 is the mass memory of the device 1, implemented for example as an embedded multimedia card (eMMC). The SOC 2 is able to read data and code images from the mass memory 4b and to write data and code images on it. Internal memories of the SOC 2 can only be accessed in the secure mode of the CPU 2a. The secure boot process ensures that software which has not been signed either by the SOC 2 or by the manufacturer of the electronic device 1 is never loaded to RAM 2b for execution.

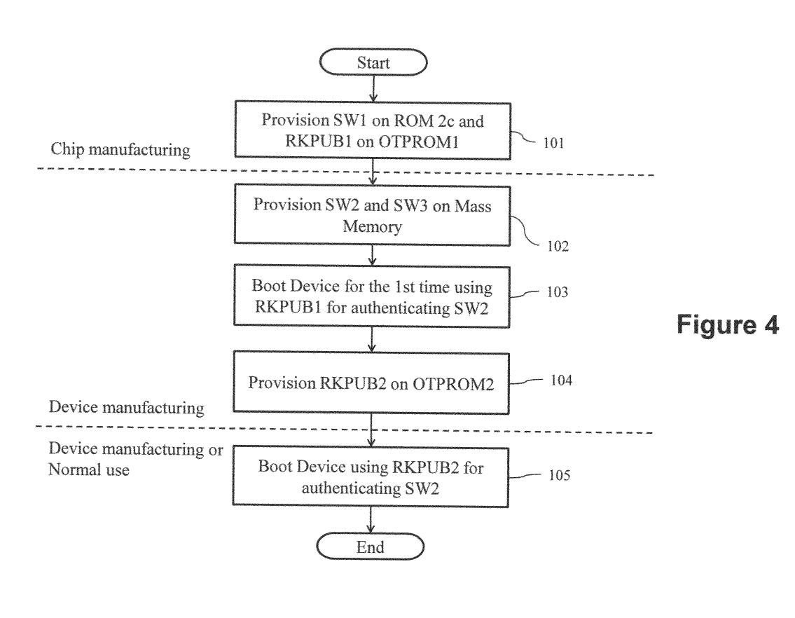

Now understanding the relevant hardware and its various purposes, FIGS. 3 and 4 show flow charts detailing how these teachings function. The shaded blocks of FIG. 3 imply that the corresponding memory 2b, 2d, 2e is available only for the secure mode, or that the corresponding software image 10, 11 is to be executed in the secure mode. During chip manufacturing, SW1 10 is provisioned on the ROM 2c and the chip manufacturer's root key RKPUB1 2d1 is provisioned on the OTPROM1 2d, as shown at FIG. 3 and at process block 101 of FIG. 4. As noted above, the chip manufacturer's root key RKPUB1 (2d1 in FIG. 3) may in fact be provided to the chip manufacturer by the device manufacturer who ordered the chips to be made, but the origin of RKPUB1 is not an essential feature. The SW1 10 contains the boot software and typically also other security routines as shown at FIG. 3. Being boot software, SW1 is always executed in the secure mode of the CPU 2a which is why it is provisioned to the ROM 2c of the SOC 2. RKPUB1 is the root key of the SOC 2. In one embodiment it is a derivative of the public key part of an asymmetric key pair generated and delivered to the chip manufacturer by the customer that is purchasing the SOC 2, where in this example the customer is the electronic device 1 manufacturer. The derivative can be for example a hash function of the public key. In other embodiments, the public key itself can be stored directly on OTPROM1, but using the entire public key would require more storage space than required by the hash of it. At this provisioning phase, changing the operative root key of the SOC 2 includes disabling the original root key RKPUB1 2d1 in the memory space OTPROM1 2d by setting the associated disable field RKPUB1_D which is 2e2 in FIG. 3, but in this example this disable field is not set. Setting this RKPUB1 value in the SOC 2 allows embodiments of this invention to be compatible with prior art methods to boot electronic devices as was summarised above. Leaving it un-set allows the device 1 to boot by authenticating SW2 using either the original key pair RKPUB1 with SRKPR1, or the new key pair RKPUB2 with SRKPR2.

Next the SOC 2 is delivered to the device manufacturer for its own provisioning, as shown by the vertical dashed line in FIG. 3. In this example, after assembling the SOC to the PCB of the host electronic device 1, software images SW2 (which may include a certificate referred to as CKPUB3 shown as 2b1 in FIG. 3), and SW3 are provisioned to the mass memory 4b of the electronic device 1. This process step is shown in FIG. 4 as block 102. This is sometimes known in the art as flashing software firmware on the device. SW2 includes executable software code and may be considered as second boot software. SW2 further includes certificates, one of which is CKPUB3. In typical manufacturing processes for many types of devices, the mass memory 4 is already provisioned with the SW2 (and possibly also the SW3) prior to the memory block 4 being assembled into the host device 1 and interfaced to the SOC 2. Block 102 of FIG. 4 covers whether the SW2 is provisioned to the mass memory 4 before or after interfacing the memory block 4 to the SOC 2.

When the electronic device 1 is booted after flashing, CPU 2a starts executing the boot software of SW1 in secure mode. After necessary initialisations have been done, SW1 starts the loading of SW2 from the mass memory 4b to RAM 2b. After the SW2 has been loaded to RAM 2b, SW1 authenticates it. During provisioning by the device manufacturer according to these teachings, the device manufacturer has attached two signatures to SW2: SRKPR1 11a and SRKPR2 11b as shown in FIG. 3. Recall from above that SRKPR1 is the result of a signature algorithm using the private key counterpart to RKPUB1 that was provisioned by the chip manufacturer, and SRKPR2 is the result of a signature algorithm using the private key counterpart to RKPUB2. Because the disabling field RKPUB1_D 2e2 has not been set, the boot software SW1 in the ROM 2B of the SOC 2 authenticates SW2 by checking that signature SRKPR1 11a has been signed with the private part of the key pair of which public key derivative RKPUB1 is part. This authentication is conventional and need not be explored further.

After that authentication of SW2, the boot SW (SW1) checks integrity and authenticity of SW2 by calculating a signature verification algorithm on the signature SRKPR1, and compares it to the corresponding hash of the whole software image SW2 that is in the signature SRKPR1. If they match, it means the SW2 has been securely loaded to RAM 2b, and then the boot SW (SW1) starts execution of the computer code of the SW2. During loading of SW2, certificate CKPUB3 is stored to the RAM 2b. This execution of SW2 by SW1 is still in the secure mode of CPU 2a. If the signature verification algorithm check fails, the boot sequence is terminated and the electronic device 1 enters an error state. SW2 includes executable software code (2nd Boot SW) and digital certificates which among other things includes CKPUB3. During loading of SW2, CKPUB3 is also stored to the RAM 2b to be used in the next phase of the boot.

Among other functions, in this example SW2 initiates loading of SW3 from the mass memory 4b to the RAM 4a. The second boot software SW2 and the security services of SW1 authenticate and integrity check the firmware SW3 in a similar manner to that by which SW2 was authenticated and integrity checked, except for SW3 the signature SRKPR3 of SW3 has been signed with the private key that is paired with public key CKPUB3 2b1. The certificate/public key CKPUB3 already resides in RAM 2b from when SW2 first loaded, and so has already been authenticated and integrity checked with SW2 as noted above. If SRKPR3 and CKPUB3 match, this means that SW3 has been successfully authenticated and integrity checked. This completes process block 103 of FIG. 4, after which the electronic device is now booted successfully to the known and pre-defined state.

At this state it is still possible to boot software on the SOC 2 which has been signed with the original keys, which in this example is the derivative of RKPUB1 that was provisioned by the chip manufacturer. In embodiments of these teachings, further boots of the device 1 using RKPUB1 can be prohibited. This is possible because the new root key can be taken into use for booting the device 1 once this final phase is complete which includes provisioning RKPUB2 at block 104 of FIG. 4. As shown at FIG. 3, RKPUB2 (2e1 of FIG. 3) will be written to the memory space OTPROM2 (2e of FIG. 3), and OTPROM2 also has a field RKPUB2_D (2d2) for disabling RKPUB2 similar to the disabling field 2e2 for RKPUB1.

Provisioning of RKPUB2 may in some embodiments be started automatically by the main firmware (SW3) but it can also be started by triggering it with a manufacturing tool such as for example using the USB port at interface 7 of FIG. 1. The new root key (or its derivative) RKPUB2 can be delivered to the electronic device 1 from the same manufacturing tool, or it may alternatively be delivered in a signed certificate that lies in SW2 or SW3. In either case, the provisioning is triggered by the main firmware SW3, and the process is done by the security services of SW1 in the secure mode. At this point the disable field RKPUB2_D is not set, meaning that provisioning of RKPUB2 is allowed. The disable field RKPUB1_D is not set, meaning that RKPUB2 has not yet been provisioned (since in this example once RKPUB2 is provisioned then RKPUB1 will be disabled via this field). With both these disabling fields not set, the security services of SW1 then provision RKPUB2 on the memory space OTPROM2 and sets RKPUB1_D. At this point the root key is changed to RKPUB2, and the original root key RKPUB1 is disabled. Alternatively, SW2 can automatically perform the programming of RKPUB2 and disabling RKPUB1, for example by having both root keys/derivatives and checking on its initial boot that RKPUB2 has not been written to OTPROM2.

When the electronic device 1 boots the next time (which for example may be in the device manufacturing phase such as testing, or later on by a retail end user) as shown at block 105 in FIG. 4, the second boot software SW2 notices that RKPUB1_D has been set and so it uses RKPUB2 for checking SRKPR2. So long as RKPUB1_D is set, it is no longer possible to boot on the SOC software images which have been signed with the original key data of which RKPUB1 was derived.

The above example utilised an asymmetric key pair, where the root key and the signing key are different (though they are mathematically linked). These teachings can also be employed where the key pair is symmetric, that is, where the root key and the signing key are the same values. For the symmetric key pair case, generally message authentication codes (MACs) would replace digital signatures. As referred to herein, the software being “signed” by a security key encompasses an asymmetric digital signature and a symmetric MAC, and the acronyms RKPUB and SPKPR are generic for either asymmetric or symmetric key pairs (or derivatives thereof or results of algorithms using the underlying key) unless specified as public and private keys or specified as an asymmetric key/derivative pair.

Additionally, the example above had a total of two OTPROMs/software signatures SRKPRs. This is not a limiting feature in that these same teachings can be extended to more than two root keys that can be installed in a secure manner. In this example, each OTPROM also contained storage for one root key and the disable field for the root key stored on the other OTPROM, but this is not a limiting feature and in a variation the root key memory space and the disable field corresponding to that same root key memory space lie on the same OTPROM. It is convenient that the disable field be on a different OTPROM from the security key it disables for several reasons: the chip manufacturer need only write to one OTPROM to program RKPUB1 and also to set RKPUB2_D for plugging a potential security hole when the chip manufacturer uses the same chip architecture for customers that do not want the root key re-programming feature; and the device manufacturer using the root key re-programming feature can also write to only one OTPROM to program RKPUB2 and also to set RKPUB1_D for disabling the original root key. Both uses are simpler when, as is anticipated to be a typical implementation, different “tools” are used by the chip manufacturer and the device manufacturer for the OTPROM programming, for example the assembly line for the chip manufacturer and the device 1 itself for the device manufacturer.

There can also be variations in the boot process as compared to that in the above example without departing from these teachings, depending on the architecture of the chip in question. For example, instead of the chip having an internal RAM 2b and an external RAM 4a, these teachings can be applied on chips having only one internal RAM 2b, or to chips having only one external RAM 4a. Sometimes the mass memory will support a feature known in the art as “execute in-place” in which no copy of the software is needed in a RAM memory and so none is made. In this case, SW2 (and the SW3 if as in the above example SW3 is used) can be directly executed from the mass-memory without departing from these teachings.

The software architecture used in the above example is also not limiting to the broader teachings presented herein. While the example used both SW2 and SW3, in other implementations the presence of SW3 is not necessary to re-program the root key according to these teachings. In other software architectures there may be further software SW4, SW5, etc. beyond SW3 that are used in the root key re-programming. All these variations are also within the scope of these teachings.

Embodiments of these teachings provide the technical effect of enabling the customer of a chipset manufacturer the ability to program chips with a new root key, even on its production line. This was not possible previously. The chips provided to the customer already contain the “original” root key, meaning that no security hole is introduced by the above embodiments; only the device manufacture having ordered the chips can change the root key. When the disable field for the original root key is set by the device manufacturer, the new root key permanently replaces the existing one in a secure way. A further technical effect is that there is no need to change the software in the mass-memory of the device when the root key is updated: that software can be authenticated by both root keys which avoids the software management of re-programming the mass memory by the chipset customer.

As a review consider the computer chip 2 which is ready for shipment to the customer. As shown in FIGS. 1 to 3, it has at least one processor (CPU, 2a), at least two one-time programmable memory spaces (OTPROMs 2d and 2e), and a read only memory (ROM) 2c. FIG. 2 further shows a RAM 2b on the chip 2. The chip manufacturer provides the chip 1 with a first of the one-time programmable memory spaces (OTPROM1, 2d) having stored thereon a root key of the chip or a derivative thereof (RKPUB1, 2d1), the ROM having stored thereon a first software program (SW1, 10) for booting the chip and with nothing stored on a second of the one-time programmable memory spaces (OTPROM2, 2e).

In one non-limiting implementation discussed in detail within the above example, besides being boot software for the chip 2 itself the SW1 is further for authenticating a second software program (SW2) and for initiating execution of the SW2, either in place when stored on a mass memory 4b that is electronically interfaced to the computer chip 2 or when loaded on a RAM 2b of the computer chip 2.

In the above non-limiting example, the computer chip further comprises a disable field (RKPUB1_D, 2e2) in one of the OTPROMs (2e in the FIG. 3 example) which is not set to disable the RKPUB1. In this same example, the chip 2 also comprised a second disable field (RKPUB2_D, 2d2) in a different one of the OTPROMs (2d in the FIG. 3 example) than the RKPUB1_D, and the chip ready for shipment to the customer also has this field not set to disable a security key if such a security key were stored in the OTPROM2. But as above, there is in fact nothing stored in the OTPROM2 when the chip is complete and ready for shipment to the customer.

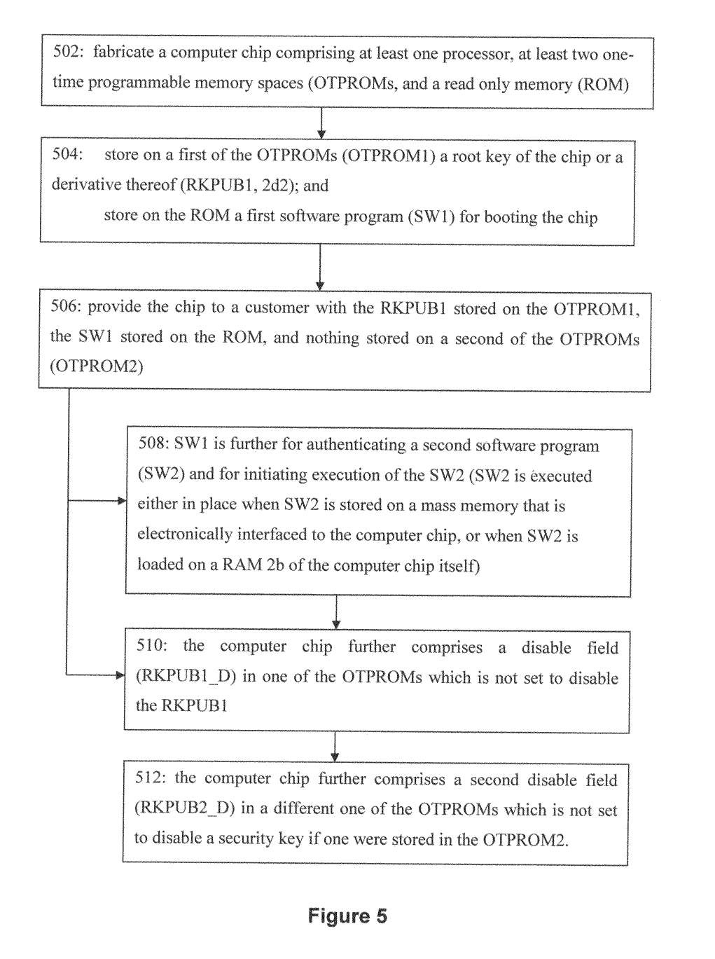

Now having summarised the chipset 2 itself, FIG. 5 presents a summary, from the perspective of the chip manufacturer in the above example, of a method for making a computer chip according to the above teachings. At block 502 the computer chip 2 is fabricated and it comprises at least one processor (CPU, 2a), at least two one-time programmable memory spaces (OTPROMs, 2d, 2e), and a read only memory (ROM 2c). It may also have a RAM 2b. Specifics of the actual chip fabrication are known in the art, for example using conventional mask and etch techniques repeated in different areas and depths of a silicon wafer to fabricate chip-level devices and electrical interconnects between them, and such fabrication processes are not detailed further herein. According to these teachings, with the chip now fabricated at block 504, the chip manufacturer then stores on a first of the one-time programmable memory spaces (OTPROM1, 2d) a root key of the chip or a derivative thereof (RKPUB1, 2d1); stores on the ROM a first software program (SW1, 10) for booting the chip; and at block 506 provides the chip to a customer with the RKPUB1 stored on the OTPROM1, the SW1 stored on the ROM, and nothing stored on a second of the one-time programmable memory spaces (OTPROM2, 2e). In the above example, the SW1 is only a first of two boot programs, and so it may only partially boot the chip and still fall within these teachings.

In the non-limiting example above and summarised at block 508, the SW1 is further for authenticating a second software program (SW2, 11) and for initiating execution of the SW2, as shown by the security services and boot SW of SW1 in FIG. 3. As noted above, the SW2 may be executed either in place when stored on a mass memory 4b that is electronically interfaced to the computer chip or when loaded on a RAM 2b of the computer chip itself. The chip manufacturer typically would not provide SW2 directly, but SW1 is configured to authenticate SW2 and to initiate execution of SW2.

In the example above and as summarised at block 510, the computer chip further comprises a disable field (RKPUB1_D, 2e2) in one of the OTPROMs, and the chip provided to the customer has the RKPUB1_D not set to disable the RKPUB1. Block 512 summarises the more particular embodiment of block 510 where the chip 2 further comprises a second disable field (RKPUB2_D, 2d2) in a different one of the OTPROMs than the RKPUB1_D; and the chip provided to the customer has the RKPUB2_D not set to disable a security key if such a security key were stored in the OTPROM2. RKPUB1_D is configured such that if it were written to, it would disable any security key (RKPUB1, 2d1) stored in the OTPROM1. RKPUB2_D is similarly configured such that if it were written to, it would disable any security key stored in the OTPROM2. But neither RKPUB2 (2e1) nor any other security key is written to OTPROM2 in the chip 2 shipped to the customer; at that point nothing has ever been written to OTPROM2 or its disable field RKPUB2_D and in some embodiments also nothing has ever been written to the other disable field RKPUB1_D, leaving these OTPROM portions available to be written to one time.

With the above fuller understanding of the computer chip 2 which in the above example is provided to the customer/device manufacturer by the chip manufacturer, now is described an example of an electronic device which the device manufacturer makes using that chip 2. The electronic device comprises at least a computer chip 2 and a memory block 4 which are electronically interfaced to communicate with one another (such an interface is shown in FIG. 2). The chip 2 comprises at least one processor 2a, at least two one-time programmable memory spaces (OTPROMs, 2d, 2e) and a read only memory (ROM 2c); and the memory block 4 comprises at least a mass memory 4b. Of course the chip 2 and the memory block 4 may include more than the above, and the memory block 4 need not be all disposed on a single semiconductor chip but different portions of different memories may be disposed at various locations within the device 1. Once the device manufacturer is finished, there will be stored a first of the one-time programmable memory spaces (OTPROM1, 2d) a root key of the chip or a derivative thereof (RKPUB1, 2d1), and there will be stored on a second of the one-time programmable memory spaces (OTPROM2, 2e) a new root key of the chip or a derivative thereof (RKPUB2, 2e1), and there will be stored on the mass memory a second software program (SW2, 11). And further there will be stored on the ROM 2c a first software program (SW1, 10) which includes a first boot software which, when executed, authenticates the SW2 and thereafter initiates execution of the SW2 which includes second boot software. One unique characteristic of the SW2 according to the above example is that SW2 can be authenticated using the RKPUB 1 or the RKPUB2. This is true even if the RKPUB 1 stored in the OTPROM1 is disabled by the field RKPUB1_D (for example, after the new root key RKPUB2 is installed and the device manufacturer wishes to disable the original root key RKPUB1); it may not be possible to authenticate SW2 using whatever may be stored in the OTPROM1 memory space but SW2 can in theory still be authenticated using the RKPUB 1 key, so long as the RKPUB 1 key is provided to the device apart from the OTPROM1 for authenticating the SW2.

If for a certain embodiment there are more than two OTPROMs on the chip 2, then in general it should be true that SW2 can be authenticated using any one of N different RKPUBs since each of those N OTPROMs may be written with a different one of N RKPUBs, where N is an integer greater than one. Having a disable field associated with each of those N OTPROMs enables the device manufacturer or other party to effectively render SW2 authenticable by the device using only one (or more generally less than N) root key (or derivative) stored in one (or less than N) of the N OTPROMs.

In the non-limiting example above there was attached to the SW2 a first signature (SRKPR1, 11a) and a second signature (SRKPR2, 11b), where SRKPR1 is the result of a signature algorithm using a private key corresponding to the RKPUB1 for authenticating SW2, and the SRKPR2 is the result of a signature algorithm using a private key corresponding to the RKPUB2 for authenticating SW2. In other embodiments a symmetric key pair is used and the first and second signatures may be referred to as first and second message authentication codes.

In the above example the computer chip further comprised a disable field (RKPUB1_D, 2e2) in one of the OTPROMs that is set to disable the RKPUB1; and the chip 2 further comprised a second disable field (RKPUB2_D, 2d2), in a different one of the OTPROMs than the RKPUB1_D, that is not set to disable the RKPUB2. The terminology ‘not set to disable’ means that if the field were set it would operate to disable whatever security key may be stored in the corresponding OTPROM; this is because as one-time programmable memories each may be written to once so using that one available write for a given OTPROM disables the corresponding key. In some embodiments the value written to the disable field is irrelevant; if it has been written to then whatever security key may be stored in the corresponding OTPROM is disabled.

A further non-limiting detail from the above example is that the computer chip 2 further comprises a random access memory (RAM, 2b) and SW1 and SW2 are characterised in that when the SW2 is loaded from the mass memory to the RAM by executing SW1, the SW2 is authenticated on and executed from the RAM, and these executions of the SW1 and SW2 are performed securely within the chip. In another embodiment SW2 can be executed in place from the mass memory 4b, but still SW2 is authenticated and initiated by SW1.

Also in the example above was the particular but non-limiting firmware implementation, in which the SW2 further comprises a certificate (CKPUB3, 2b1) which is loaded to the RAM 2b with the SW2. In this embodiment the mass memory 4b has further stored thereon a third software program (SW3, 12) which comprises firmware whose execution is initiated by at least the SW2, and the SW3 includes an attached third signature (SRKPR3, 12a). SW2 is characterised in that executing the SW2 a) initiates loading of the SW3 to the RAM 2b and b) authenticating the loaded SW3 by checking that SRKPR3 is the result of a signature algorithm using a private key corresponding to the CKPUB3. As noted above, if symmetric keys are used instead then also SRKPR3 would be a third message authentication code. In some embodiments some key pairs for authenticating some software programs may be asymmetric and other key pairs for authenticating different software programs may be symmetric.

In any of the above embodiments the device manufacturer may mount or otherwise dispose the computer chip on a printed circuit board within the electronic device, and make that chip function as a security master for the electronic device. As a few non-limiting examples the electronic device may comprise at least one of: a smartphone; an internet appliance, a camera, a laptop computer; a tablet computer; a desktop computer; a wearable computer (a smartphone or internet appliance disposed within eyeglasses or a wristband type of apparatus are two non-limiting examples of a wearable computer); a server; a television, and a control device configured to be embedded in and to control at least some electronic systems of a vehicle such as an automobile, truck or other wheeled or tracked vehicle, a ship, an aircraft or a space vehicle. Such electronic devices which may be adapted to host embodiments of these teachings are known in the art and need not be explained further herein.

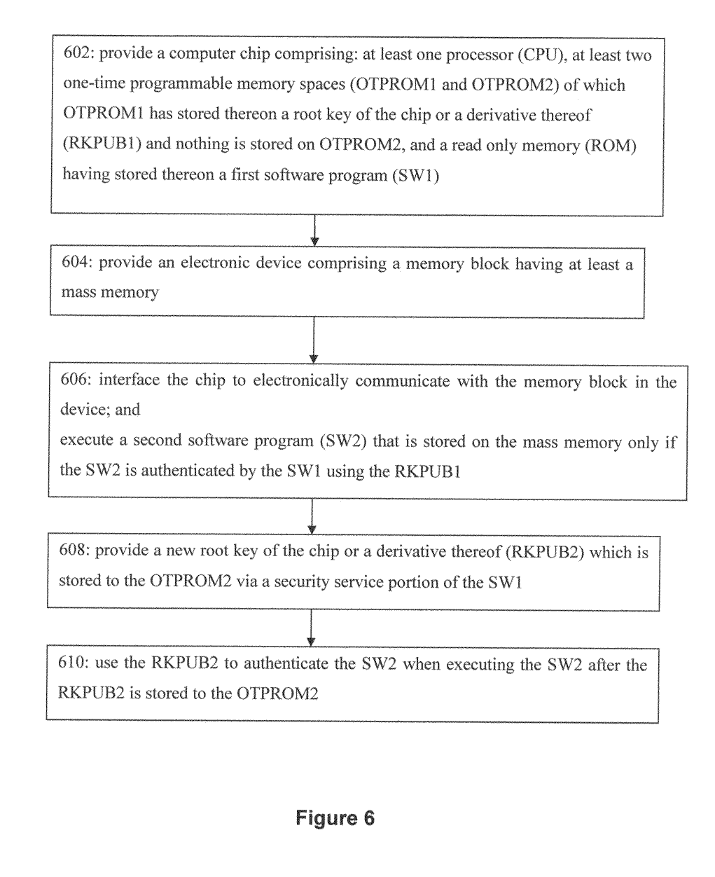

Now having summarised the electronic device 1 itself, FIG. 6 presents a summary, from the perspective of the device manufacturer in the above example, of a method for making an electronic device 1 according to the above teachings. At block 602 a computer chip 2 is provided, the chip comprising: at least one processor (CPU 2a), at least two one-time programmable memory spaces (OTPROMs, 2d, 2e) of which a first of the one-time programmable memory spaces (OTPROM1 2d) has stored thereon a root key of the chip or a derivative thereof (RKPUB1, 2d1) and nothing is stored on a second of the one-time programmable memory spaces (OTPROM2, 2e), and a read only memory (ROM, 2c) having stored thereon a first software program (SW1, 10). That the chip is “provided” in block 602 does not imply manufacture of the chip from bulk silicon or other raw materials: the chip 2 may simply be provided to an assembly line at the device manufacturer's plant from a storage location on or off site to that same plant. At block 604 an electronic device is provided and this device comprises a memory block 4 having at least a mass memory 4b. This also may be manufactured by a third party as a component for the completed device and purchased by the device manufacturer, to which the device manufacturer may add hardware and store related software to embody some or all of the further functional blocks 3 and 5 to 8 of FIG. 1 and then form at least some of the interfaces between them. Then at block 606 the device manufacturer performs two main steps: it interfaces the chip 2 to electronically communicate with the memory block 4 in the device 1; and it executes a second software program (SW2, 11) that is stored on the mass memory 4b only if the SW2 is authenticated by the SW1 using the RKPUB1 (this latter step is software-automated; if the authentication fails then execution of SW2 will not be initiated). The SW2 may be loaded to the mass memory 4 prior to or after the memory block 4 being interfaced to the chip, and can be done by the device manufacturer, the memory block manufacturer, or some third party. Block 610 has the device manufacturer providing a new root key of the chip or a derivative thereof (RKPUB2, 2e1) which is stored to the OTPROM2 2e via a security service portion of the SW1 10. Finally, block 610 tells that the RKPUB2 is used to authenticate the SW2 when executing the SW2 after the RKPUB2 is stored to the OTPROM2.

Some of the non-limiting implementations for FIG. 6 which are detailed in the above example are now summarised for completeness. In one embodiment the SW2 has attached a first signature (SRKPR1, 11a) and a second signature (SRKPR2, 11b); wherein the SW2 is authenticated by the SW1 using the RKPUB1 as in block 606 of FIG. 6 by checking that SRKPR1 is the result of a signature algorithm using a private key corresponding to the RKPUB1, and further the RKPUB2 is used to authenticate the SW2 after the RKPUB2 is stored to the OTPROM2 by checking that SRKPR2 is the result of a signature algorithm using a private key corresponding to the RKPUB2.

In another embodiment which may be combined with that of the paragraph immediately above, the chip provided at block 602 of FIG. 6 further comprises a disable field (RKPUB1_D, 2e2) in one of the OTPROMs that disables the RKPUB1, and the device manufacturer's process further comprises automatically setting the RKPUB1_D to disable use of the RKPUB1 once the RKPUB2 is stored to the OTPROM2.

In a more particular embodiment following that of the paragraph immediately above, the chip provided at block 602 of FIG. 6 further comprises a second disable field (RKPUB2_D, 2d2), in a different one of the OTPROMs than the RKPUB1_D, which disables the RKPUB2 (or any security key stored in its place).

In a still further embodiment flowing from FIG. 6 and any of the other implementations in the above three paragraphs, the provided chip further comprises a random access memory (RAM, 2b) and the SW2 is loaded from the mass memory to the RAM by executing SW1, and SW2 is authenticated on and executed from the RAM. In this embodiment, execution of the SW1 and SW2 are performed securely within the chip. A further detail that can be added to this embodiment, which is non-limiting since it represents a particular software hierarchy that is not essential for practising the invention, is that the SW2 further comprises a certificate (CKPUB3, 2b1) which is loaded to the RAM with the SW2. In this case, the storing of the SW2 on the mass memory as in block 606 of FIG. 6 further comprises storing a third software program (SW3, 12) on the mass memory, wherein the SW3 has attached a third signature (SRKPR3, 12a); and further in this case executing the SW2 as in block 606 of FIG. 6 initiates loading of the SW3 to the RAM and authenticating the loaded SW3 by checking that SRKPR3 is a private key or a derivative thereof corresponding to the CKPUB3. In this particularised embodiment from the example above, the SW1 comprises a first boot software, the SW2 comprises a second boot software whose execution is initiated by the SW1, and the SW3 comprises firmware whose execution is initiated by at least the SW2.

For any of the above implementations for making the electronic device, in an example interfacing the chip to electronically communicate with the memory block in the electronic device as in block 606 of FIG. 6 comprises assembling the chip 2 to a printed circuit board (PCB) and setting the chip to be a security master for the electronic device. The PCB is shown by a dashed outline in FIG. 2 as also having the memory block 4 mounted thereon but this is not a limiting feature of the invention. The method summarised at FIG. 6 and according to the various non-limiting embodiments above may be executed by a manufacturer of the electronic device who obtains the provided computer chip from a chip manufacturer. Various examples of the electronic device are listed above at the description of the device itself.

The logic diagrams of FIGS. 5 and 6 may each be considered to illustrate the operation of examples of a method, and a result of execution of a computer program stored in a computer readable memory, and a specific manner in which components of a chip or an electronic device are configured to cause that respective chip or electronic device to operate. Certain of the various blocks shown in each of FIGS. 5 and 6 may also be considered as a plurality of coupled logic circuit elements constructed to carry out the associated function(s), or specific result of strings of computer program code or instructions stored in a memory.

Such blocks and the functions they represent are non-limiting examples, and may be practised in various components such as integrated circuit chips and modules that automate at least some portions of an assembly line process for making the chip 2 or device 1, and the exemplary embodiments of the chip according to this invention may be realised in an apparatus that is embodied as an integrated circuit. The integrated circuit, or circuits, may comprise circuitry (as well as possibly firmware) for embodying at least one or more of a data processor or data processors such as the illustrated CPU, or more than one processor, that is/are configurable so as to operate in accordance with the exemplary embodiments of this invention.

Such circuit/circuitry embodiments include any of the following: (a) hardware-only circuit implementations (such as implementations in only analog and/or digital circuitry) and (b) combinations of circuits and software (and/or firmware), such as: (i) a combination of processor(s) or (ii) portions of processor(s)/software (including digital signal processor(s)), software, and memory(ies) that work together to cause an apparatus, such as a user equipment/UE, to perform the various functions summarised at FIG. 5 and at FIG. 6, and (c) circuits, such as a microprocessor(s) or a portion of a microprocessor(s), that require software or firmware for operation, even if the software or firmware is not physically present (such as SW2 and SW3 not yet being installed on the chip as shipped from the chip manufacturer). This definition of “circuitry” applies to all uses of this term in this specification, including in any claims. As a further example, as used in this specification, the term “circuitry” would also cover an implementation of merely a processor (or multiple processors) or portion of a processor and its (or their) accompanying software and/or firmware. The term “circuitry” also covers, for example, an application specific integrated circuit ASIC or a similar integrated circuit which operates according to these teachings.

The memories described herein are computer-readable memories which are well known in the art, and various embodiments of them include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the above described ROM, RAM, mass memory and OTPROMs. Various embodiments of the processor(s) shown in FIG. 2 as a CPU 2a include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While some exemplary embodiments have been described above in the context of a chip manufacturer and a device manufacturer, these are only for clarity of description and are not limiting; it may be that the chip is made in stages by different manufacturers and further it may be that a re-seller of the device programs the SW2 and/or SW3 and re-sets the RKPUB.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method for changing a security key on a computer chip, the computer chip comprising at least one processor, at least two one-time programmable memory spaces (OTPROMs) of which a first of the one-time programmable memory spaces (OTPROM1) has stored thereon a root key of the chip or a derivative thereof (RKPUB1) and nothing is stored on a second of the one-time programmable memory spaces (OTPROM2), and a read only memory (ROM) having stored thereon a first software program (SW1), the method comprising:
interfacing the chip to electronically communicate with a memory block of an electronic device comprising the memory block, the memory block having at least a mass memory;
only if a second software program SW2 stored on the mass memory is authenticated by the SW1 using the RKPUB1, executing the SW2;
providing a new root key of the chip or a derivative thereof (RKPUB2) which is stored to the OTPROM2 via a security service portion of the SW1; and
using the RKPUB2 to authenticate the SW2 when executing the SW2 after the RKPUB2 is stored to the OTPROM2.

2. The method according to claim 1, wherein the SW2 has attached a first signature (SRKPR1) and a second signature (SRKPR2);
the SW2 is authenticated by the SW1 using the RKPUB1 by checking that SRKPR1 is the result of a signature algorithm using a private key corresponding to the RKPUB1, and
the RKPUB2 is used to authenticate the SW2 after the RKPUB2 is stored to the OTPROM2 by checking that SRKPR2 is the result of a signature algorithm using a private key corresponding to the RKPUB2.

3. The method according to claim 1, wherein the chip comprises a disable field (RKPUB1_D) in one of the OTPROMs that disables the RKPUB1, and the method comprises automatically setting the RKPUB1_D to disable use of the RKPUB1 once the RKPUB2 is stored to the OTPROM2.

4. The method according to claim 3, wherein the chip comprises a second disable field (RKPUB2_D), in a different one of the OTPROMs than the RKPUB1_D, that disables the RKPUB2.

5. The method according to claim 1, wherein the chip comprises a random access memory (RAM) and the SW2 is loaded from the mass memory to the RAM by executing SW1, and SW2 is authenticated on and executed from the RAM, wherein execution of the SW1 and SW2 are performed securely within the chip.

6. The method according to claim 5, wherein:
the SW2 comprises a certificate (CKPUB3) which is loaded to the RAM with the SW2;
storing the SW2 on the mass memory comprises storing a third software program (SW3) on the mass memory, wherein the SW3 has attached a third signature (SRKPR3); and
executing the SW2 initiates loading of the SW3 to the RAM and authenticating the loaded SW3 by checking that SRKPR3 is a private key or a derivative thereof corresponding to the CKPUB3;
wherein the SW1 comprises a first boot software, the SW2 comprises a second boot software whose execution is initiated by the SW1, and the SW3 comprises firmware whose execution is initiated by at least the SW2.

7. The method according to claim 1, wherein interfacing the chip to electronically communicate with the memory block in the electronic device comprises assembling the chip to a printed circuit board (PCB) and setting the chip to be a security master for the electronic device.

8. The method according to claim 1, wherein the method is executed by a manufacturer of the electronic device who obtains the provided computer chip from a chip manufacturer; and
the electronic device comprises at least one of: a smartphone; an internet appliance; a camera; a laptop, tablet, desktop or wearable computer; a server; a television, and a control device configured to be embedded in and to control at least some electronic systems of a vehicle.

9. An electronic device comprising:
a computer chip comprising at least one processor, at least two one-time programmable memory spaces (OTPROMs) and a read only memory (ROM); and
a memory block comprising at least a mass memory and electronically interfaced to communicate with the computer chip;
wherein:
a first of the one-time programmable memory spaces (OTPROM1) has stored thereon a root key of the chip or a derivative thereof (RKPUB1);
a second of the one-time programmable memory spaces (OTPROM2) has stored thereon a new root key of the chip or a derivative thereof (RKPUB2);
the mass memory has stored thereon a second software program (SW2);
the ROM has stored thereon a first software program (SW1) which includes a first boot software which, when executed, authenticates SW2 and thereafter initiates execution of SW2 which includes second boot software; and
the SW2 can be authenticated using the RKPUB1 or the RKPUB2.

10. The electronic device according to claim 9, wherein the SW2 has attached a first signature (SRKPR1) and a second signature (SRKPR2);
wherein SRKPR1 is the result of a signature algorithm using a private key corresponding to the RKPUB1 for authenticating SW2, and the SRKPR2 is the result of a signature algorithm using a private key corresponding to the RKPUB2 for authenticating SW2.

11. The electronic device according to claim 9, wherein the computer chip comprises a disable field (RKPUB1_D) in one of the OTPROMs that is set to disable the RKPUB1.

12. The electronic device according to claim 11, wherein the computer chip comprises a second disable field (RKPUB2_D), in a different one of the OTPROMs than the RKPUB1_D, that is not set to disable the RKPUB2.

13. The electronic device according to claim 9, wherein the computer chip comprises a random access memory (RAM) and, when the SW2 is loaded from the mass memory to the RAM by executing SW1, the SW2 is authenticated on and executed from the RAM,
wherein execution of the SW1 and SW2 are performed securely within the chip.

14. The electronic device according to claim 13, wherein:
the SW2 comprises a certificate (CKPUB3) which is loaded to the RAM with the SW2;
the mass memory has stored thereon a third software program (SW3) which comprises firmware whose execution is initiated by at least the SW2, and the SW3 includes an attached third signature (SRKPR3); and
executing the SW2 initiates loading of the SW3 to the RAM and authenticating the loaded SW3 by checking that SRKPR3 is the result of a signature algorithm using a private key corresponding to the CKPUB3.

15. The electronic device according to claim 9, wherein the computer chip is disposed on a printed circuit board within the electronic device and is a security master for the electronic device.

16. The electronic device according to claim 9, wherein the electronic device comprises at least one of: a smartphone; an internet appliance; a camera; a laptop, tablet, desktop or wearable computer; a server; a television, and a control device configured to be embedded in and to control at least some electronic systems of a vehicle.

17-20. (canceled)

21. A computer chip, comprising:
at least one processor,
at least two one-time programmable memory spaces (OTPROMs), and
a read only memory (ROM);
wherein:
a first of the one-time programmable memory spaces (OTPROM1) has stored thereon a root key of the chip or a derivative thereof (RKPUB1);
the ROM has stored thereon a first software program (SW1) for booting the chip; and
nothing is stored on a second of the one-time programmable memory spaces (OTPROM2).

22. The computer chip according to claim 21, wherein the SW1 is further for authenticating a second software program (SW2) and for initiating execution of the SW2 either in place when stored on a mass memory that is electronically interfaced to the computer chip or when loaded on a random access memory (RAM) of the computer chip.

23. The computer chip according to claim 21, wherein the computer chip comprises a disable field (RKPUB1_D) in one of the OTPROMs which is not set to disable the RKPUB1.

24. The computer chip according to claim 23, wherein the computer chip comprises a second disable field (RKPUB2_D) in a different one of the OTPROMs than the RKPUB1_D which is not set to disable a security key if such a security key were stored in the OTPROM2.

25-26. (canceled)
